(19) United States
(12) Patent Application Publication
(10) Pub. No.: US 2023/0150047 A1
(43) Pub. Date: May 18, 2023

(54) GUIDE DRESSER, CUTTER HEADS AND METHODS OF USE THEREOF

(71) Applicant: Internal Machinery Solutions Ltd., West Kelowna (CA)

(72) Inventors: Gary Stroud, West Kelowna (CA); Vincent Bergeron, Prince George (CA)

(21) Appl. No.: 17/528,804

(22) Filed: Nov. 17, 2021

(51) Int. Cl. B23D 63/16

(52) U.S. Cl. CPC B23D 63/164

(57) ABSTRACT

There is provided a guide dresser for milling a saw guide, the guide dresser comprising first and second cutter assemblies that are slidably mounted on a rail or slide system so as to be adjustable, in operation, between an open position and a closed position. There is also provided cutter heads and methods for milling a saw guide.

### TECHNICAL FIELD

The present disclosure generally relates to a guide dresser, cutter heads and methods of use thereof, and more particularly to guide dressers having movable cutter assemblies for milling a saw guide.

### BACKGROUND

Production of lumber from raw logs typically involves a first step, called primary breakdown, which involves recovering an elongate square center from a log using head rig equipment. Head rigs generally comprise a large stationary circular saw or a band saw and a travelling carriage. The travelling carriage rotationally transports a log back and forth through the head rig to remove a series of rounded slabs from outer edges of the log thereby producing the squared center of the log, which is commonly called a “cant”. In some processes, cants are produced with two squared-off opposing sides. Primary breakdown typically produces 2-sided and 4-sided cants, rounded edge slabs, and sometimes, large boards.

The cants, slabs and boards produced during primary breakdown are further processed during secondary breakdown processes whereby large rectangular side flitches having two opposing parallel sides, are cut from the sides of cants with band saws or circular saws. Flitches are then typically broken down into functional lumber with equipment having multiple parallel circular saw blades mounted onto a fixed driven arbor, commonly known as circular gang saws. The processing step for producing flitches from cants is known as “reducing” while production of functional lumber from flitches comprises multiple steps referred to as “edging” and “re-sawing”. High volume throughput systems often combine the reducing and edging steps into one piece of equipment operating under high saw speeds to enable rapid cutting of wood against high pressures forced by rapid throughput of cants and flitches.

Pressing forces applied by high volume throughput of flitches and lumber pieces against circular gang saws often cause undesired lateral movements and vibrations of individual saw blades resulting in deterioration in blade stability and reduced dimensional accuracy in the final finished lumber pieces. It is common practice to provide saw guides interposed between individual blades to maintain their spacing and to minimize the extent of vibration that may occur. The saw guides are securely fixed into place between the individual circular blades by engagement with equipment frame rails or other support elements to provide stability to the saw blades prior to commencing operations.

Accurate saw guides improve the performance of the saws (e.g. gang saws) in the production of lumber. In this regard, guide dressers have been developed to mill and machine saw guides to improve and maintain their longevity and accuracy. However, existing guide dressers and cutter heads are not accurate enough to maintain saw guides within desired tolerances. Also, existing guide dressers and cutters are difficult to set properly.

A need therefore exists for an improved guide dresser and cutter heads that exhibit ease of use and a high degree of accuracy in milling and machining saw guides.

### SUMMARY

The present disclosure provides guide dressers, cutter heads and methods for milling or machining a saw guide. The present disclosure recognizes that there are problems in the current existing guide dresser technologies in respect of the apparatus, cutter heads and methods, and provides an improved guide dresser and cutter heads.

An advantage of the present disclosure is the provision of guide dressers and components thereof (e.g. cutter assemblies, cutter heads, etc.) having improved characteristics over existing technologies, tools, processes and systems.

In an embodiment, the present disclosure relates to a guide dresser for milling a saw guide, the guide dresser comprising: a rail or slide system; a first cutter assembly slidably mounted on the rail or slide system, the first cutter assembly having a first rotatable cutter head; a second cutter assembly slidably mounted on the rail or slide system, the second cutter assembly having a second rotatable cutter head; and a guide mount for receiving and maintaining in a stationary position a saw guide, the stationary position being between the first rotatable cutter head and the second rotatable cutter head and the rail or slide system aligned for moving each of the first cutter assembly and second cutter assembly towards or away from the guide mount, the guide dresser being adjustable between an open position and a closed position by slidable movement of the first cutter assembly, the second cutter assembly, or both, wherein: when in the open position, one or both of the first cutter assembly and the second cutter assembly are positioned away from the guide mount on the rail system, and when in the closed position, both the first cutter assembly and the second cutter assembly are positioned proximal to the guide mount on the rail system, such that both the first cutter head and second cutter head are capable of contacting the saw guide when it is received within the guide mount.

In an embodiment, the present disclosure relates to a method for milling a saw guide, the method comprising: moving a first cutter assembly and a second cutter assembly on a rail or slide system to engage a first cutter head of the first cutter assembly and a second cutter head of the second cutter assembly against opposing sides of a stationary saw guide; and milling or machining the stationary saw guide.

In an embodiment, the present disclosure relates to a cutter head, the cutter head comprising a circular disc and one or more removable knife retention apparatuses, each of the one or more removable knife retention apparatuses for receiving a knife.

In an embodiment, the present disclosure relates to a cutter head, the cutter head comprising a circular disc having two or more grooves on a face thereof, each groove of the two or more grooves for receiving two or more cutting implements.

In an embodiment, the present disclosure relates to a kit comprising one or more components of the cutter heads described herein. For example, in an embodiment, the present disclosure relates to a kit comprising a circular disc for use as a cutter head, and one or more removable knife retention apparatuses. The kit may further comprise one or more knives for mounting in each of the removable knife retention apparatuses. In another embodiment, the kit may comprise a circular disc having two or more grooves on a face thereof for use as a cutter head, and two or more cutting implements.

Other aspects and embodiments of the disclosure are evident in view of the detailed description provided herein.

### BRIEF DESCRIPTION OF THE DRAWINGS

Further advantages, permutations and combinations of the invention will now appear from the above and from the following detailed description of the various particular embodiments of the invention taken together with the accompanying drawings, each of which are intended to be non limiting, in which:

FIGS. 1A-B are side views of a guide dresser according to some embodiments of the present disclosure, wherein FIG. 1A shows the guide dresser in an open position and FIG. 1B shows the guide dresser in a closed position.

FIGS. 2A-B are top views of the guide dresser shown in FIGS. 1A-B, wherein FIG. 2A is the guide dresser in the open position and FIG. 2B is the guide dresser in the closed position.

FIGS. 3A-E show an exemplary cutter head of the present disclosure shaped as a circular disc and having knives contained within knife retention apparatuses. FIG. 3A is a perspective view of a front side, FIG. 3B is a top view of the front side, FIG. 3C is a perspective view of a back side, FIG. 3D is a side view, and FIG. 3E is an extracted view of an exemplary knife retention apparatus.

FIGS. 4A-C show another exemplary cutter head of the present disclosure shaped as a circular disc and having carbide inserts as the milling implement. FIG. 4A is a perspective view of a front side, FIG. 4B is a top view of the front side, and FIG. 4C is a side view.

FIGS. 5A-B show a cutter assembly according to some embodiments of the present disclosure, wherein FIG. 5A is a front view and FIG. 5B is a cross-sectional view along the A-A line sown in FIG. 5A.

FIG. 6 is an exploded perspective view of an exemplary pivot component for use in association with embodiments of the cutter assembly of the present disclosure.

FIG. 7 is an exploded perspective view of a two-part pivotable block component for use in association with embodiments of the cutter assembly of the present disclosure

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the suitable methods and materials are described below.

The embodiments of the present disclosure pertain to guide dressers, cutter heads and methods having improved functionality for milling and machining saw guides. Guide dressers of the present disclosure have moveable cutter assemblies for engaging and disengaging a saw guide. In select embodiments, cutter assemblies are slidably mounted on a rail or slide system so as to be adjustable between an open position and a closed position. Cutter heads of the present disclosure have unique features and configurations for improved milling of a saw guide.

The present disclosure provides a number of advantages over existing technologies. For example, existing guide dressers are not accurate enough and are difficult to set properly. This is due to a number of factors, including for example the saw guide being fed into the cutters. Moreover, existing cutter heads are often set in position by hand and are rarely capable of milling a saw guide to desired or even acceptable tolerances.

An advantage of the present disclosure is the provision of guide dressers having improved characteristics over existing technologies, in particular having fewer moving parts and using a configuration by which improved cutter heads are moved directly into a saw guide for milling and machining operations. In the guide dressers of the present disclosure, the saw guide remains stationary and the cutter heads are fed into the saw guide on slidably mounted cutter assemblies. In certain embodiments, the process is automated and the cutter heads on respective cutter assemblies are fed into the saw guide using programmable computer numerical control (CNC) programming.

In some embodiments, the present disclosure relates to a guide dresser for milling a saw guide, the guide dresser comprising: a rail or slide system; a first cutter assembly slidably mounted on the rail or slide system, the first cutter assembly having a first rotatable cutter head; a second cutter assembly slidably mounted on the rail or slide system, the second cutter assembly having a second rotatable cutter head; and a guide mount for receiving and maintaining in a stationary position a saw guide, the stationary position being between the first rotatable cutter head and the second rotatable cutter head and the rail or slide system aligned for moving each of the first cutter assembly and second cutter assembly towards or away from the guide mount, the guide dresser being adjustable between an open position and a closed position by slidable movement of the first cutter assembly, the second cutter assembly, or both, wherein: when in the open position, one or both of the first cutter assembly and the second cutter assembly are positioned away from the guide mount on the rail system, and when in the closed position, both the first cutter assembly and the second cutter assembly are positioned proximal to the guide mount on the rail system, such that both the first cutter head and second cutter head are capable of contacting the saw guide when it is received within the guide mount.

It will be appreciated that while the exemplary embodiments of the guide dresser as shown in the figures herein have the rail or slide system in a horizontal orientation generally parallel to the ground or floor, other configurations are contemplated, such as for example where the slide or rail system is tilted or in an up/down configuration. The rail or slide system also need not provide slidable movement in a linear direction, but may also provide a curved path of movement or any other configuration.

Reference will now be made in detail to exemplary embodiments of the disclosure, wherein numerals refer to like components, examples of which are illustrated in the accompanying drawings that further show exemplary embodiments, without limitation.

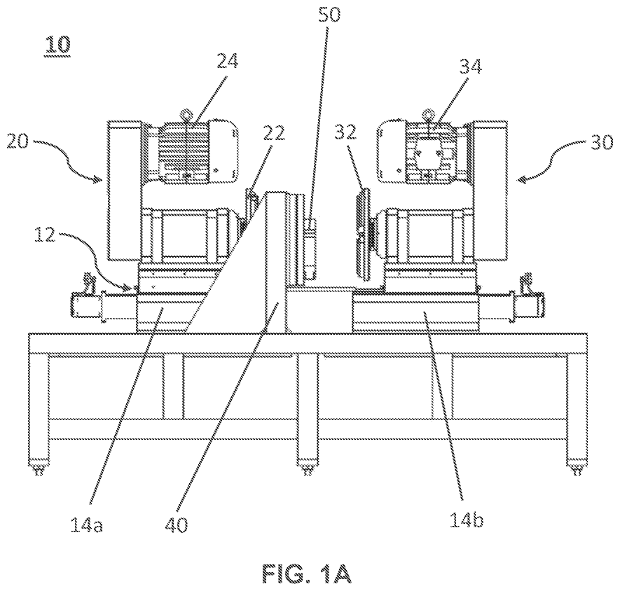

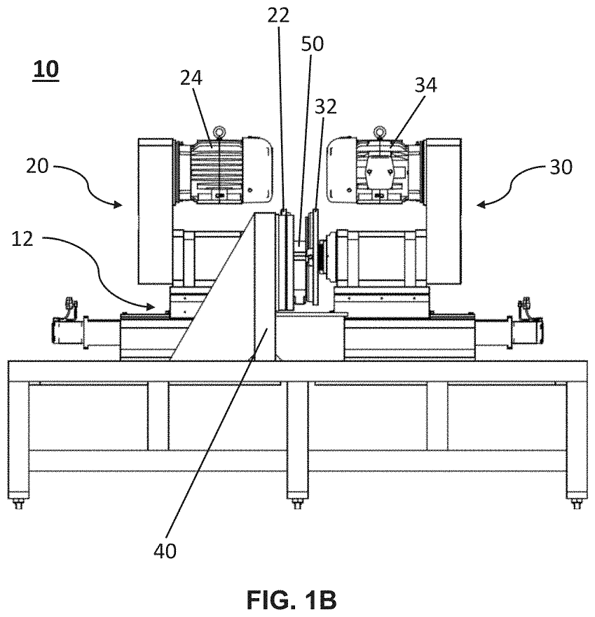

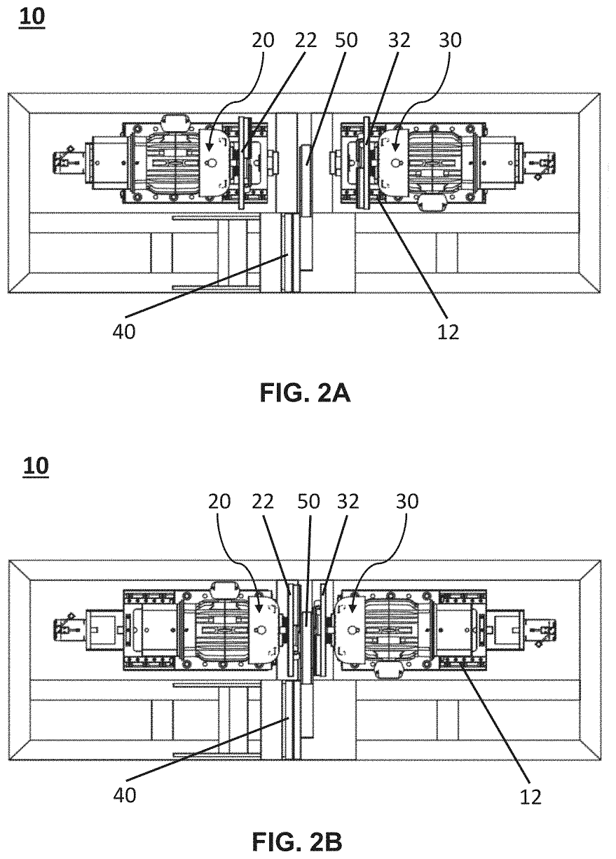

FIGS. 1A-B and FIGS. 2A-B illustrate side and top views, respectively, of an exemplary embodiment of a guide dresser 10 according the present disclosure. The guide dresser 10 as shown in FIGS. 1A-B and FIGS. 2A-B comprises a rail or slide system 12, a first cutter assembly 20 having a first rotatable cutter head 22 and a motor 24, a second cutter assembly 30 having a second rotatable cutter head 32 and a motor 34, and a guide mount 40. The guide mount 40 is capable of receiving a saw guide 50.

In the guide dressers of the present disclosure, the first cutter assembly 20 and the second cutter assembly 30 are slidably mounted on the rail or slide system 12. By “rail or slide system”, it is meant to refer to any arrangement of components that allow for movement of the first and second cutter assemblies (20, 30). The rail or slide system 12 may, for example and without limitation, include wheels, tracks, trolleys, grooves, slides, bearings, or any combination thereof. In an embodiment, the rail or slide system 12 is a track-and-trolley system. In an embodiment, the rail or slide system 12 comprises a ballscrew and linear bearings. By “slidably mounted”, it is meant to refer to any type of movement whereby the cutter assembly (20, 30) is moved from one position to another while attached to the rail or slide system 12, or components thereof. The first cutter assembly 20 and the second cutter assembly 30 may be mounted on, or attached to, the rail or slide system 12 by any suitable means.

In some embodiments of the present disclosure, the rail or slide system 12 comprises a single continuous rail or slide component having both the first cutter assembly 20 and the second cutter assembly 30 slidably mounted thereon. For example, the rail or slide system 12 may extend a length that traverses past (e.g. in front of) the guide mount 40, with the first cutter assembly 20 mounted on the rail or slide system 12 on one side of the guide mount 40, and the second cutter assembly 30 mounted on the rail or slide system 12 on the other side of the guide mount 40.

In other embodiments, the rail or slide system 12 comprises a separate apparatus or structure for each of the first cutter assembly 20 and the second cutter assembly 30. For example, as shown in FIGS. 1A-B each of the first cutter assembly 20 and the second cutter assembly 30 may be mounted on its own rail or slide apparatus (14a, 14b).

The rail or slide system 12 may be configured for linear movement of each cutter assembly (20, 30), meaning that the cutter assemblies (20, 30) are moved along a straight path in the rail or slide system 12. Alternatively, the rail or slide system 12 may have a configuration that provides for non-linear movement of the cutter assemblies (20, 30). For example, the cutter assemblies (20, 30) may travel along a curved or arched path to approach the position of the guide mount 40.

Irrespective of the configuration of the rail or slide system 12, movement of the cutter assemblies (20, 30) may be manual, automated, or any combination thereof. In an embodiment, the position of each cutter assembly (20, 30) on the rail or slide system 12 is controlled with programmable controller, such as a programmable logic controller (PLC) and/or computer numerical control (CNC) programming. In an embodiment, the rail or slide system 12 comprises its own independent motor to drive movement of each cutter assembly (20, 30) on the rail or slide system 12. The motor may, for example, be a servo motor. In an embodiment, the rail or slide system 12 comprises servo motor-controlled ballscrew and linear bearings for programmable and repeatable positioning of each cutter assembly (20, 30). The rpm and spherical alignment of the cutter heads (22, 32) may also be similarly control by manual processes, automated processes, or a combination thereof.

Referring again to FIGS. 1A-B and FIGS. 2A-B, the first cutter assembly 20 and the second cutter assembly 30 each have respective rotatable cutter heads (22, 32). As used herein, the term “rotatable cutter head” is intended to refer to the cutting apparatus for engaging and milling a saw guide 50. The rotatable cutter head is, for example, mounted on a spindle to which rotational movement is applied. The rotational movement may be from any suitable source. In an embodiment, each cutter assembly (20, 30) has a motor (24, 34) to drive the rotational movement. The motor (24, 34) may, for example, be a belt drive motor which supplies rotational movement to a belt that is connected to both the motor and a spindle connect to the cutter heads (22, 32). In some embodiments, each cutter assembly (20, 30) has its own motor (24, 34) and drive system for providing rotational movement to the cutter heads (22, 32). In other embodiments, a single motor may be used to provide rotational movement to the cutter heads (22, 32) on both cutter assemblies (20, 30). Other arrangement and configurations to provide rotational movement to the cutter heads (22, 32) will be well-appreciated by the skilled person.

In operation, the guide dressers of the present disclosure maintain a saw guide 50 in a stationary position. In this regard, the guide dressers comprise a guide mount 40 for receiving and maintaining a saw guide 50 in this stationary position. By “stationary position”, it is meant that the saw guide 50 is held in a fixed or substantially fixed position while one or both of the cutter assemblies (20, 30) are moved along the rail or slide system 12 to engage the saw guide 50. The guide mount 40 is configured for removable attachment of the saw guide 50 and is of sufficient strength to withstand the forces imparted by the cutter heads (22, 32) and keep the saw guide 50 stationary during milling operations.

The guide mount 40 is in a suitable position on the guide dresser 10 to place the saw guide 50 between the first rotatable cutter head 22 and the second rotatable cutter head 32. By this, it is meant that when the first cutter assembly 20 and second cutter assembly 30 travel to an end of, or position on, the rail or slide system 12 that is proximal to the guide mount 40, the cutter heads (22, 32) are positioned so as to be capable of engaging the saw guide 50 for milling and machining operations. In some embodiments, the guide mount 40 is positioned between the first cutter assembly 20 and second cutter assembly 30, but slightly askew so that the guide mount 40 does not interfere with the ability of the cutter heads (22, 32) to contact the saw guide 50. In some embodiments, the guide mount 40 is positioned to one side of the guide dresser 10 and the guide mount 40 has an extension component that places the saw guide 50 in the stationary position between the first rotatable cutter head 20 and the second rotatable cutter head 30.

In operation, the rail or slide system 12 permits movement or travel of the first rotatable cutter head 20 and the second rotatable cutter head 30 towards and away from the guide mount 40 to alternate between an “open position” and a “closed position”. Thus, the guide dresser 10 of the present disclosure is capable of being adjusted between an open position and a closed position.

As used herein, the expression “open position” is intended to refer to a configuration of the guide dresser 10 whereby both the first cutter assembly 20 and second cutter assembly 30 are positioned away from the guide mount 40 on the rail or slide system 12. By “positioned away”, it is meant that the cutter assembly (20, 30) is in a position on the rail or slide system 12 that the cutter head (22, 32) would not be capable of engaging or contacting the saw guide 50 when the saw guide 50 is received by the guide mount 40. In an embodiment, in the open position both the first cutter assembly 20 and second cutter assembly 30 are positioned as far away from the guide mount 40 as is permitted by the rail or slide system 12. In other embodiments, the first cutter assembly 20 and second cutter assembly 30 may independently be at any distance away from the guide mount 40 along the rail or slide system 12, and each may be at the same or a different distance away from the guide mount 40.

As used herein, the expression “closed position” is intended to refer to a configuration of the guide dresser 10 whereby both the first cutter assembly 20 and second cutter assembly 30 are positioned such that both the first cutter head 22 and second cutter head 32 are capable of contacting the saw guide 50 when it is received within the guide mount 40. In the closed position, the guide dresser 10 can operate to mill both sides of the saw guide 50.

In addition to the open position and closed position, it should be understood that the guide dresser 10 disclosed herein is capable of being operated in such a manner that only one of the cutter assemblies (20, 30) is positioned to allow the cutter head (22, 32) to engage or contact the saw guide 50, and thereby mill a single side of the saw guide 50.

In an embodiment, the guide dresser 10 of the present disclosure is fully enclosed within an encasement having a door. In an embodiment, the door is located to provide access to the guide mount 40. For milling a saw guide 50, a user or automated controller need only open the door and install a saw guide 50 on the guide mount 40. Installation of the saw guide 50 on the guide mount 40 is an easy process and is accurately repeatable to provide for reliability in accuracy of milling. In an embodiment, the guide dresser 10 can only be operated when a magnetic door lock is engaged.

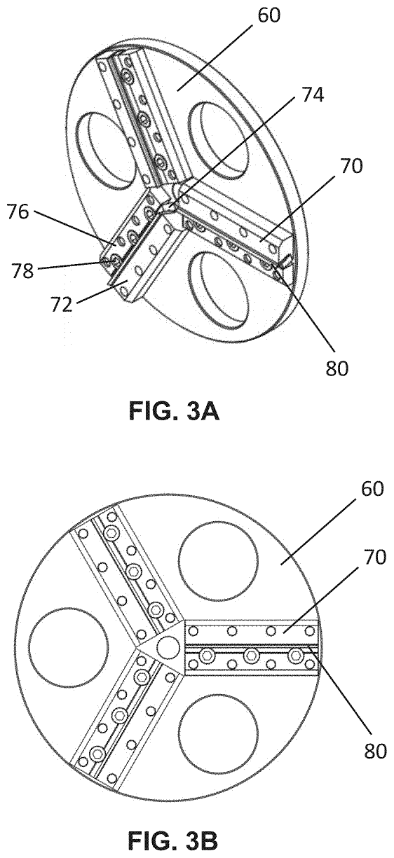

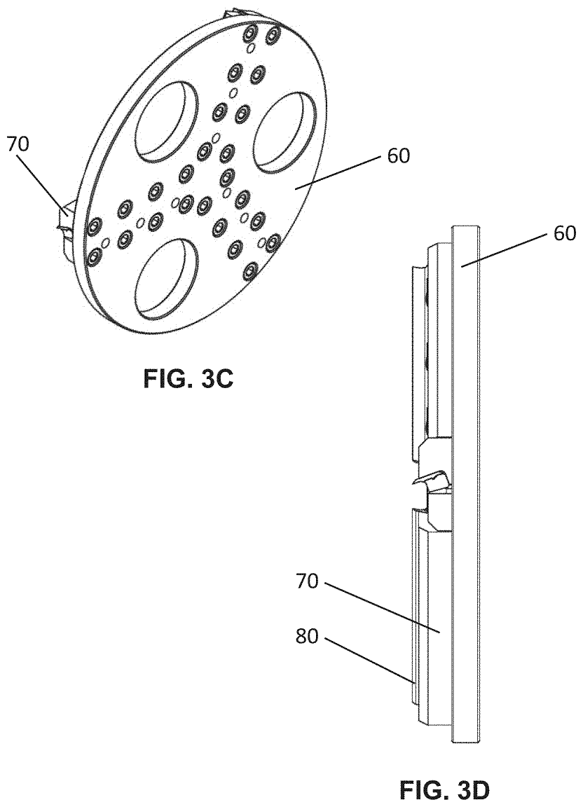

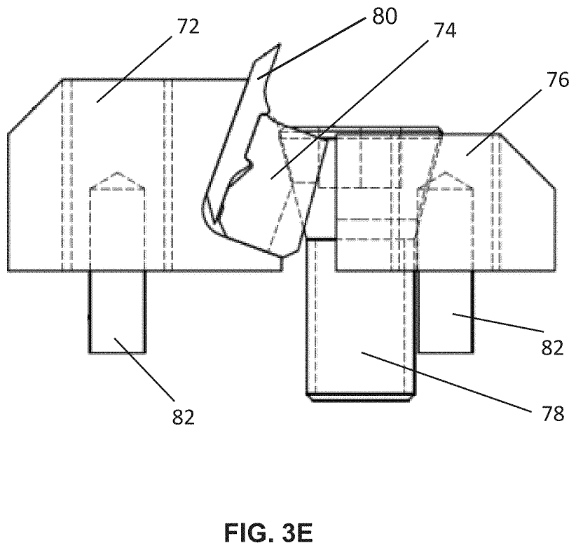

Referring now to FIGS. 3A to 3E, each cutter assembly of the present disclosure includes a cutter head (22, 32). An embodiment of a cutter head (22, 32) of the present disclosure is shown in FIGS. 3A to 3E. In this embodiment, the cutter head (22, 32) comprises a circular disc 60 and one or more removable knife retention apparatuses 70, each of the one or more removable knife retention apparatuses for receiving a knife 80. The circular disc 60 is shaped like a wheel, having a front surface, a back surface and an outer perimeter surface. The circular disc 60 may have apertures traversing from its front surface to back surface. By “front surface” it is meant the side that performs the milling of the saw guide 50, and the back surface is the opposite side. Each of the knife retention apparatuses 70 can be permanently or removably mounted on the front surface of the circular disc 60.

In an embodiment, the knife retention apparatus 70 is a configuration that can be removably mounted to the circular disc 60. An exemplary embodiment is shown in FIG. 3E where the knife retention apparatus 70 comprises a knife holder 72, a knife gib 74, a knife clamp 76, and one or more knife gib screws 78. In this configuration, the knife 80 is positioned between the knife holder 72 and the knife gib 74, with the knife jib 74 pressing against the knife 80 by way a force applied from the one of more knife screws 78. The knife clamp 76 is on the opposite side of the knife screws 78 from the knife gib 74 to act as a counterbalance to the force of the knife screws 78, for example by way of opposing notches in the knife gib 74 and knife clamp 76 into which at least a portion of the knife screw 78 is received. In some embodiments, the knife holder 72 and the knife clamp 76 include one or more mounting apertures for receiving a pin 82 protruding from the circular disc 60. In an embodiment, the pins 82 are dowel pins. The mounting apertures and pins 82 provide accuracy and rigidity the positioning of the knife retention apparatus 70, and therefore the position of the knife 80.

Many adjustments to the configuration of the knife retention apparatus 70 can be made. For example, the knife holder 72 can be manufactured to allow any desired knife angle by adjusting the angle of the wall of the knife holder 72 against which the knife 80 is held. In an embodiment, the angle can be any angle between about 15.0° and about 80.0° relative to the front surface of the circular disc 60. In an embodiment, the angle is between about 45.0° and about 75.0° relative to the front surface of the circular disc 60. As shown in FIG. 3A, the knife holder 72, knife gib 74, and knife clamp 76 may be of an elongate shape configured to substantially span a radius of the circular disc 60 when mounted on the circular disc 60. By “elongate shape”, it is meant a structure that is longer in one direction (e.g. length) than in other directions (e.g. width, height). For example, and without limitation, an elongate shape may be similar to a rectangle in shape. By “substantially span a radius of the circular disc”, it is meant to extend from near the center of the circular disc 60 to near the outer edge of the circular disc 60. This shape and configuration may be preferred for rigidity and accuracy, but other configurations can also be used.

In an embodiment, each knife retention apparatus 70 includes two or more knife screws 78. In an embodiment, each knife retention apparatus 70 includes 2, 3, 4, 5 or more knife screws 78. In an embodiment, each knife retention apparatus 70 includes three knife screws 78.

The cutter head (22, 32) may include any number of the knife retention apparatuses 70 on the circular disc 60. In an embodiment, cutter head (22, 32) includes 2, 3, 4, 5, 6, 7, 8, 9, 10 or more knife retention apparatuses 70 on the circular disc 60. In a particular embodiment, cutter head (22, 32) includes 3, 4 or 5 knife retention apparatuses 70 on the circular disc 60. The components of the knife retention apparatuses 70 may mounted on the circular disc 60 by any suitable means. In an embodiment, the knife retention apparatus 70 is mounted to the circular disc 60 by screws, bolts or other types of fasterners. In operation, each knife retention apparatus 70 would have a knife 80 received therein, with the blade protruding outwards.

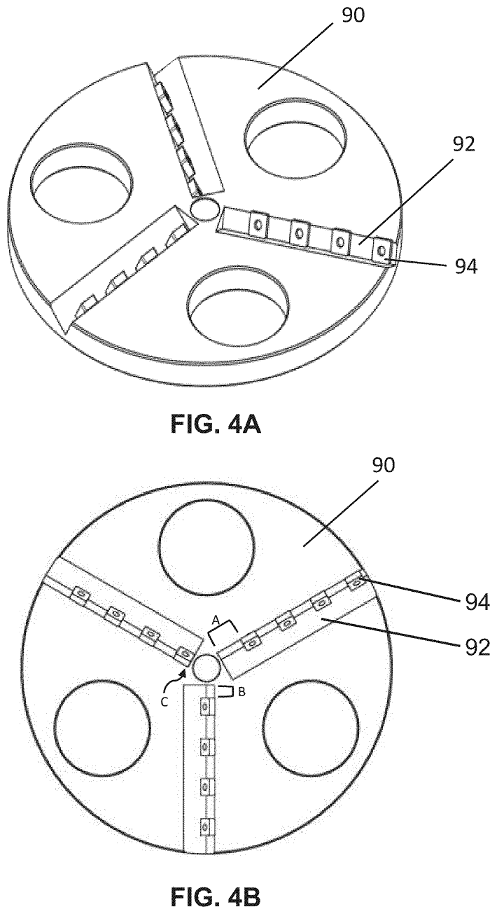

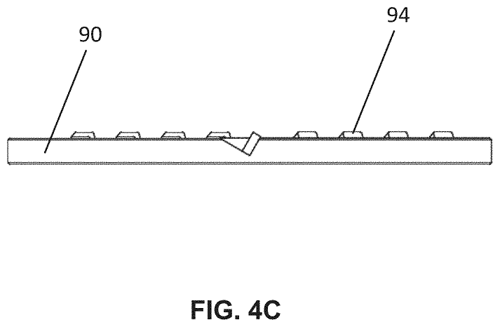

Another exemplary embodiment of a cutter head (22, 32) of the present disclosure is shown in FIGS. 4A to 4C. In this embodiment, the cutter head (22, 32) comprises a circular disc 90 having grooves 92 on a front face thereof. By “front surface” it is again meant the side that performs the milling of the saw guide 50. Similar to circular disc 60, circular disc 90 having grooves 92 may have apertures traversing from its front surface to back surface. By “grooves”, it is meant an indent or depression in the surface.

The grooves 92 may be of any suitable shape to receive two or more cutting implements 94. In an embodiment, each groove 92 is an elongate shape configured to substantially span a radius of the circular disc. By “elongate shape”, it is meant an indent or depression that is longer in one direction (e.g. length) than in other directions (e.g. width, height). For example, and without limitation, an elongate shape of groove 92 may be a channel, in particular a linear channel. By “substantially span a radius of the circular disc”, it is meant to extend from near the center of the circular disc 60 to near or at the outer edge of the circular disc 60. As shown in FIG. 4A, in an embodiment groove 92 extends from near the center of the circular disc 60 to the outer perimeter, with a portion of the outer perimeter surface also removed to form the groove 92. In other embodiments, the groove 92 may not extend into the outer perimeter surface, but rather may end just before the outer edge of the circular disc 92.

The cutter head (22, 32) may include any number of grooves. In an embodiment, the cutter head (22, 32) has at least two grooves 92. In an embodiment, the cutter head (22, 32) has 2, 3, 4, 5, 6, 7, 8, 9, 10, or more grooves 92. In an embodiment, the cutter head (22, 32) has 3, 4 or 5 grooves 92. In an embodiment, the cutter head (22, 32) has 3, 4 or 5 grooves 92 and each of the grooves 92 is an elongate shape configured to substantially span a radius of the circular disc. In an embodiment, the cutter head (22, 32) has three grooves 92 and each of the grooves 92 is an elongate shape configured to substantially span a radius of the circular disc.

The cutting implements 94 may be positioned at any suitable position within the groove 92 to expose a cutting surface for milling a saw guide 50, and there may be any suitable number of cutting implements 94 within each groove 92. In an embodiment, each groove 92 has at least two cutting implements 94 that are separate from each other. In an embodiment, each groove 92 independently has 2, 3, 4, 5, 6, 7, 8, 9, 10, or more cutting implements 94 that are separate from each other. In an embodiment, each groove 92 independently has 3, 4 or 5 cutting implements 94 that are separate from each other. Each groove 92 may have the same or a different number of cutting implements 94. In an embodiment, each groove 92 has four cutting implements 94 that are separate from each other.

In an embodiment, when two or more of the cutting implements 94 are positioned within a respective groove 92, the two or more cutting implements 94 are substantially equally spaced from each other along a radially extending wall within each groove 92. By “substantially equally spaced apart” it is meant that the distance or spacing between each of the cutting implements 94 along a length of the groove 92 is about the same. An example of this is shown in FIG. 3A where cutting implements 94 that are of a square shape are each spaced about the same distance from each other within groove 92. In other embodiments, the cutting implements 94 may not be equally spaced apart within the groove 94.

In an embodiment, when there are two or more grooves 92, the cutting implements 94 in each groove 92 may be radially offset from the cutting implements in another groove 92. For example, the cutting implements 94 in each groove 92 may be offset from the center of the circular disc 90 by a different distance. An example of this is shown in FIG. 4B where the cutting implement 94 closest to the center of the disc in each groove is positioned a different distance away from the center (as shown by A, B and C). By spacing identical cutting implements 94 at different distances from the center of the circular disc 90, and then having the cutting implements 94 equally spaced apart within the groove 92, this causes each cutting implement 94 to follow a different circular path upon rotation of the cutter head (22, 32). Thus, upon circular rotation, the two or more cutting implements 94 in each groove cuts a different circular area than the two or more cutting implements 94 in the other grooves. By “circular area” it is meant to refer to the area in the circular path of all of the cutting implements 94 within a respective groove. Since the cutting implements 94 are spaced apart, there would be alternating ‘cut’ and ‘cut’ paths for each groove 92. In an embodiment, the cutting implements 94 in each groove can be arranged such the different circular area cut by the cutting implements 94 in each groove overlaps with a portion of the different circular area cut by the cutting implements 94 in at least one of the other grooves. This can be configured for any number of grooves 92 and any number of cutting implements 94 within each groove 92.

The cutting implements 94 may be any suitable cutting device for milling a saw guide 50. In an embodiment, the cutting implement 94 is a knife. In an embodiment, the cutting implements 94 are comprised of carbide. In an embodiment, the cutting implements 94 are approximately square or rectangle pieces of carbide. The cutting implements 94 may be secured to the circular disc 90 in any suitable manner. In an embodiment, the cutting implements 94 are secured to the circular disc 90 a screw or a clamp. In operation, each cutting implement 94 protrudes outwards from the grooves 92 by a sufficient amount to provide for milling of a saw guide 50 (see exemplary in FIG. 4C). The angle of the wall of the groove may be adjusted to change the angle by which the cutting implement 94 contacts the saw guide 50.

In an embodiment, the guide dresser 10 as disclosed herein comprises the cutter heads (22, 32) as disclosed herein. Combined usage of the guide dresser 10 and cutter heads (22, 32) of the present disclosure is advantageous in providing more accurate and reliable milling of saw guides 50.

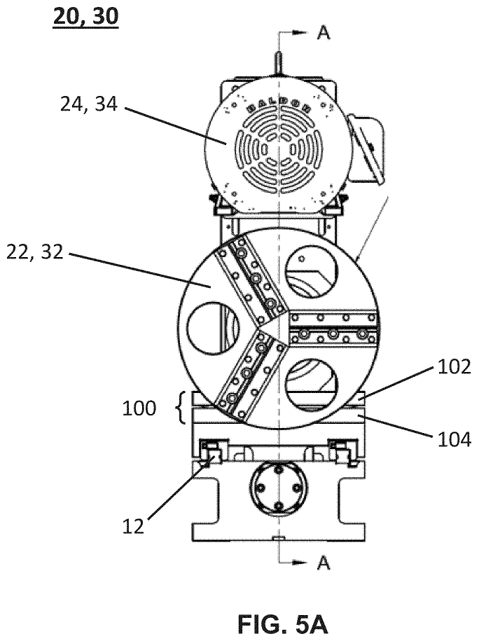

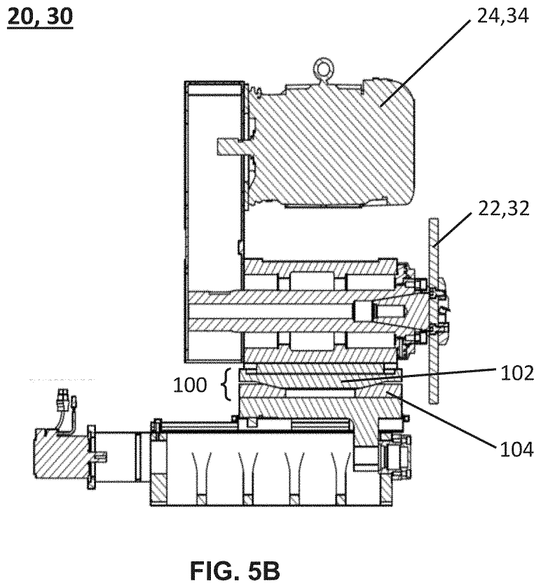

Referring now to FIGS. 5A and 5B, in some embodiments one or both of the first cutter assembly 20 and the second head cutter assembly 30 may include a pivot component 100 for adjusting alignment of the respective cutter head (22, 32) in relation to a saw guide 50 to be milled. The pivot component 100 may be located on the underside of the cutter assembly (20, 30) and may be integral thereto or a separate component attached in some manner to the cutter assembly (20, 30). When equipped, the pivot component 100 is capable of allowing each cutter assembly to tilt independently in any direction to thereby adjust the alignment of the cutter heads (22, 32) in relation to a saw guide. Titling of the cutter heads (22, 32) can provide for more accurate and precise milling and machining of the saw guide. Since the cutter heads (22, 32) can tilt in any direction by way of the pivot component 100, the pivot component 100 provides a means of spherical adjustment.

In an embodiment, the pivot component 100 of the cutter assembly (20, 30) allows for adjusting vertical alignment of the respective cutter head (22, 32). By “vertical alignment” it is meant to refer to the vertical plane of the cutter head (22, 32), which may be perfectly perpendicular to the plane of travel of the cutter assembly (20, 30) on the rail or slide system 12, or may be slightly offset. In an embodiment, the vertical alignment is perfectly perpendicular to the plane of travel of the cutter assembly (20, 30). In an embodiment, the vertical alignment a straight up-down orientation. In some embodiments, the vertical alignment is offset from perpendicular to the plane of travel by about 0.1°, about 0.2°, about 0.3°, about 0.4°, about 0.5°, about 0.6°, about 0.7°, about 0.8°, about 0.9°, about 1.0°, about 1.25°, about 1.5°, about 1.75°, about 2.0°, about 2.25°, about 2.5°, about 2.75°, about 3.0°, about 3.5°, about 4.0°, about 4.5°, or about 5.0°.

In an embodiment, both the first cutter assembly 20 and the second cutter assembly 30 comprise a pivot component 100 for independently adjusting alignment of the respective cutter heads (22, 32).

In an embodiment, the pivot component 100 includes an upper part 102 and a lower part 104. The upper part 102 and lower part 104 may be of any suitable configuration to allow pivotable movement therebetween. In an embodiment, the upper part 102 is shaped like a spherical plate having a curved bottom that rests within a cupped portion of the lower part 104 (e.g. a spherical plate atop a spherical cup).

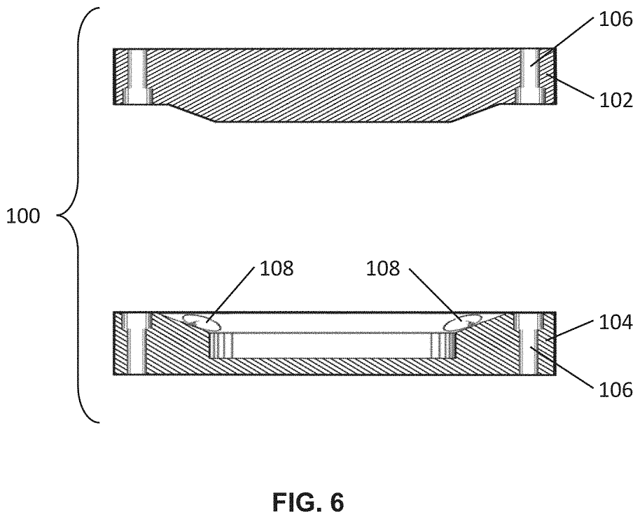

With reference to FIG. 6, a further embodiment of a pivot component 100 is shown in which the upper part 102 and a lower part 104 each comprise a threaded bore 106 for receiving a bolt (not shown) to affix the upper part 102 to the cutter assembly (20, 30) and the lower part 104 to the slide or rail system 12 or a base that is slidably mounted to the rail or slide system 12. Further, one or more convex caps 108 (e.g. protruding circular bumps) are provided on the shoulder of the cupped surface of the lower part 104 to facilitate the ease of pivotable adjustments.

Further suitable pivot components 100 for use in association with the guide dresser of the present disclosure may include a two-part pivotable block component, for example as disclosed in U.S. Pat. Nos. 9,199,320 and 10,267,450.

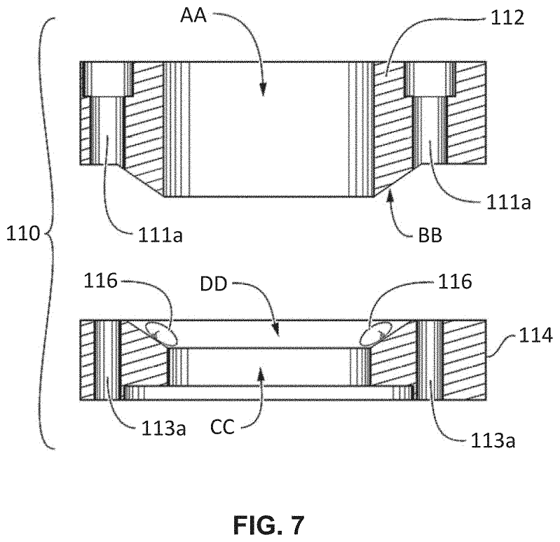

An exemplary two-part pivotable block component 110 that may be used in association with the cutter assembly (20, 30) of the present disclosure is shown in FIG. 7. The two-part block component 110 comprises an upper block 112 and a lower block 114. The upper block 112 may be provided with threaded bores 111a aligned with bores 113a for receiving and engaging aligning bolts (not shown). Alternatively, the lower block may be provided with threaded bores for engaging aligning bolts inserted through bores provided therefore in the upper block.

The upper block 112 may be provided with a bore AA for receiving therethrough a post extending downward from the cutter assembly (20, 30). The upper block 112 has an outwardly inclined downward extending shoulder BB in the form of a frustoconical surface having a plane relative to a horizontal plane, selected from a range of between about 5° to about 75°, and more particularly between about 10° to about 45°. An exemplary suitable plane is about 10°, about 12.5°, about 15°, about 17.5°, about 20°, about 22.5°, about 25°, about 27.5°, about 30°, about 32.5°, about 35°, about 37.5°, about 40°, about 42.5°, about 45°, about 47.5°, or about 50°.

The lower block 114 may be provided with a bore CC that has a larger diameter than bore AA provided in upper block 112. It is preferable that the diameter of bore CC provides a gap between the lower block 114 and a post extending therethrough, for example a gap of about 2 mm, about 3 mm, about 4 mm, about 5 mm, about 6 mm, about 7 mm, about 8 mm, about 9 mm, about 10 mm, or anywhere therebetween. The lower block 114 has an inwardly receding inclined shoulder DD in the form of a frustoconical surface having a plane relative to the plane of the outwardly extending shoulder BB, that is offset to the plane of AA for example by about 0.25°, about 0.50°, about 0.75°, about 1.0°, about 1.25°, about 1.5°, about 1.75°, about 2.0°, about 2.25°, about 2.5°, about 2.75°, about 3.0°, about 3.5°, about 4.0°, about 4.5°, or about 5.0°. The offset in the planes between the outwardly inclined shoulder BB of upper block 112 and the inwardly receding inclined shoulder DD of lower block 114 enables precise pivotable adjustments of the cutter assembly (20, 30) in a three-dimensional space, and thereby alignment of the cutter head (22, 32). If so desired, one or more convex caps 116 may be provided on the upper shoulder BB or the lower shoulder DD (as shown in FIG. 7) to facilitate the ease of pivotable adjustments of the two-part block component 110. It is optional and within the scope of the present disclosure to provide the lower block 114 with an outwardly inclined upward extending shoulder, and to provide the upper block 112 with the inwardly receding inclined shoulder.

In other embodiments, the present disclosure relates to a method for milling a saw guide, the method comprising: moving a first cutter assembly 20 and a second cutter assembly 30 on a rail or slide system 12 to engage a first cutter head 22 of the first cutter assembly 20 and a second cutter head 32 of the second cutter assembly 30 against opposing sides of a stationary saw guide 50; and milling or machining the stationary saw guide 50.

In an embodiment of the methods herein, the position of each cutter assembly (20, 30) on the rail or slide system 12 is controlled with programmable controller, such as a programmable logic controller (PLC) and/or computer numerical control (CNC) programming. In an embodiment, the rail or slide system 12 comprises its own independent motor to drive movement of each cutter assembly (20, 30) on the rail or slide system 12. The motor may, for example, be a servo motor. In an embodiment, the rail or slide system 12 comprises servo motor-controlled ballscrew and linear bearings for programmable and repeatable positioning of each cutter assembly (20, 30). The rpm and spherical alignment of the cutter heads (22, 32) may also be similarly control by automated processes.

In an embodiment of the methods disclosed herein, milling of a saw guide 50 using the movable cutter assemblies (20, 30) and the cutter heads (22, 32) of the present disclosure is capable of cutting to high tolerances (e.g. cut to within 0.0005″).

In other embodiments, the present disclosure relates to a kit comprising one or more components of the cutter heads (22, 32) described herein. For example, in an embodiment, the present disclosure relates to a kit comprising a circular disc 60 for use as a cutter head (22, 32), and one or more removable knife retention apparatuses 70 as disclosed herein. The kit may further comprise one or more knives 80 for mounting in each of the removable knife retention apparatuses 70. In another embodiment, the kit may comprise a circular disc 90 having two or more grooves 92 on a face thereof for use as a cutter head, and two or more cutting implements 94.

In the present disclosure, all terms referred to in singular form are meant to encompass plural forms of the same. Likewise, all terms referred to in plural form are meant to encompass singular forms of the same. Unless defined otherwise, all technical and scientific terms used herein have the same meaning as commonly understood by one of ordinary skill in the art to which this disclosure pertains.

As used herein, the term “about” refers to an approximately +/−10% variation from a given value. It is to be understood that such a variation is always included in any given value provided herein, whether or not it is specifically referred to.

It should be understood that the compositions and methods are described in terms of “comprising,” “containing,” or “including” various components or steps, the compositions and methods can also “consist essentially of or” consist of the various components and steps. Moreover, the indefinite articles “a” or “an,” as used in the claims, are defined herein to mean one or more than one of the element that it introduces.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Although individual embodiments are dis-cussed, the disclosure covers all combinations of all those embodiments. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure. If there is any conflict in the usages of a word or term in this specification and one or more patent(s) or other documents that may be referenced herein, the definitions that are consistent with this specification should be adopted.

Many obvious variations of the embodiments set out herein will suggest themselves to those skilled in the art in light of the present disclosure. Such obvious variations are within the full intended scope of the appended claims.

1. A guide dresser for milling a saw guide, the guide dresser comprising:
a rail or slide system;
a first cutter assembly slidably mounted on the rail or slide system, the first cutter assembly having a first rotatable cutter head;
a second cutter assembly slidably mounted on the rail or slide system, the second cutter assembly having a second rotatable cutter head; and
a guide mount for receiving and maintaining in a stationary position a saw guide, the stationary position being between the first rotatable cutter head and the second rotatable cutter head and the rail or slide system aligned for moving each of the first cutter assembly and second cutter assembly towards or away from the guide mount,
the guide dresser being adjustable between an open position and a closed position by slidable movement of the first cutter assembly, the second cutter assembly, or both, wherein:
when in the open position, both the first cutter assembly and the second cutter assembly are positioned away from the guide mount on the rail system, and
when in the closed position, both the first cutter assembly and the second cutter assembly are positioned proximal to the guide mount on the rail system, such that both the first cutter head and second cutter head are capable of contacting the saw guide when it is received within the guide mount.

2. The guide dresser of claim 1, wherein each of the first cutter assembly and the second cutter assembly comprise a motor to impart rotational movement to the first and second rotatable cutter head.

3. The guide dresser of claim 1, wherein each of the first cutter assembly and the second cutter assembly comprise a pivot component for independently adjusting alignment of the first cutter head and the second cutter head.

4. The guide dresser of claim 3, wherein the pivot component is a two-part pivotable block component.

5. The guide dresser of claim 4, wherein the two-part pivotable block component comprises an upper spherical plate and a lower spherical cup, the upper spherical plate pivotably and slidably engaged with the lower spherical cup.

6. The guide dresser of claim 4, wherein the two-part pivotable block component comprises:
an upper block that is engaged with the first cutter assembly or the second cutter assembly; and
a lower block that is slidably mounted to the rail or slide system or, alternatively, is engaged with a base that is slidably mounted to the rail or slide system,
wherein the upper block has a first inclined surface in a first plane for pivotably and slidably engaging a second inclined surface in a second plane provided on the lower block, and wherein:
the first inclined surface in the first plane is at an angle defined by a first angle from a horizontal plant;
the second inclined surface in the second plane is at an angle defined by a second angle from the horizontal plane; and
the first angle and the second angle are different angles.

7. The guide dresser of claim 6, wherein the first inclined surface of the upper block is outwardly extending and the second inclined surface of the lower block is inwardly receding, and wherein one or both of the first inclined surface and the second inclined surface is provided with at least one convex cap extending outward therefrom.

8. The guide dresser of claim 4, wherein the two-part pivotable block component comprises:
an upper block that is engaged with the first cutter assembly or the second cutter assembly; and
a lower block that is slidably mounted to the rail or slide system or is engaged with a base that is slidably mounted to the rail or slide system,
wherein the upper block has a first frustoconical surface for pivotably engaging a second frustoconical surface provided therefor on the lower block, and wherein one or both of the first frustoconical surface and the second frustoconical surface has at least one convex cap extending outwardly therefrom for facilitating pivotable adjustment of the two-part block component.

9. The guide dresser of claim 8, wherein the first frustoconical surface of the upper block is outwardly extending and the second frustoconical surface of the lower block is inwardly receding.

10. The guide dresser of claim 1, wherein the rail or slide system comprises:
a first rail or slide apparatus having the first cutter assembly slidably mounted thereon; and
a second rail or slide apparatus having the second cutter assembly slidably mounted thereon.

11. The guide dresser of claim 1, which comprises a servo motor controlled ballscrew for modulating slidable movement of the first cutter assembly and the second cutter assembly along the rail or slide system.

12. The guide dresser of claim 1, wherein in operation the saw guide remains in the stationary position and the first and second cutter heads are fed into the saw guide by slidable movement of the first cutter assembly and the second cutter assembly towards the guide mount using automated and/or programmable CNC controls.

13. The guide dresser of claim 1, wherein:
each of the first cutter head and the second cutter head is a circular disc comprising one or more knives projecting from a side of the circular disc;
the circular disc comprises a knife retention apparatus for holding each of the one or more knives in place; and
the knife retention apparatus comprises a knife holder, a knife gib, a knife gib screw, and a knife clamp.

14. The guide dresser of claim 1, wherein:
each of the first cutter head and the second cutter head is a circular disc comprising two or more grooves on a side of the circular disc into which two or more cutting implements are mounted, the cutting implements comprised of carbide;
the two or more cutting implements in each groove of the two or more grooves are offset from the center of the circular disc by a different distance along a radially extending wall as compared to the two or more cutting implements in the other grooves; and
upon rotational movement of the circular disc, the two or more cutting implements in each groove of the two or more grooves cuts a different circular area than the two or more cutting implements in the other grooves.

15. A cutter head, the cutter head comprising a circular disc and one or more removable knife retention apparatuses, each of the one or more removable knife retention apparatuses for receiving a knife.

16. The cutter head of claim 15, wherein each of the one of more removable knife retention apparatuses comprises a knife holder, a knife gib, a knife clamp, and one or more knife gib screws.

17. The cutter head of claim 16, wherein:
each of the knife holder, the knife gib and the knife clamp are an elongate shape configured to substantially span a radius of the circular disc when mounted on the circular disc; and
the knife gib and the knife clamp have corresponding notches for receiving a portion of the knife gib screw.

18. The cutter head of claim 16, wherein, when the removable knife retention apparatus is assembled on the circular disc to receive the knife, the knife is positioned between the knife holder and the knife gib to project a blade of the knife outwardly therefrom, and the knife is held in position by a force applied to the knife by the knife gib, the force exerted and maintained by the knife screw.

19. The cutter head of claim 15, comprising at least three of the one or more removable knife retention apparatuses mounted on the circular disc, each of the one or more removable knife retention apparatuses having the knife received therein.

20. A cutter head, the cutter head comprising a circular disc having two or more grooves on a face thereof, each groove of the two or more grooves for receiving two or more cutting implements.

21. The cutter head of claim 20, wherein each groove of the two or more grooves is an elongate shape configured to substantially span a radius of the circular disc.

22. The cutter head of claim 21, wherein, when received in the two or more grooves, each of the two or more cutting implements are substantially equally spaced from each other along a radially extending wall within each groove of the two or more grooves.

23. The cutter head of claim 22, wherein, when received in the two or more grooves, the two or more cutting implements in each groove of the two or more grooves are offset from the center of the circular disc by a different distance along the radially extending wall as compared to the two or more cutting implements in the other grooves; and
when in operation in a circular rotation, the two or more cutting implements in each groove of the two or more grooves cuts a different circular area than the two or more cutting implements in the other grooves.

24. The cutter head of claim 23, wherein, when in operation in the circular rotation, the different circular area cut by the two or more cutting implements in each groove overlaps with a portion of the different circular area cut by the two or more cutting implements in at least one of the other grooves.

25. The cutter head of claim 20, wherein the two or more cutting implements are comprised of carbide.
